(19) United States
(12) Patent Application Publication
(10) Pub. No.: US 2007/0153296 A1
(43) Pub. Date: Jul. 5, 2007

(54) Optical measuring device for measuring a cavity

(75) Inventor: Anton Schick, Velden (DE)

Correspondence Address: SIEMENS SCHWEIZ AG;I-47, INTELLECTUAL PROPERTY, ALBISRIEDERSTRASSE 245, ZURICH, CH-8047, CH

(73) Assignee: SIEMENS AKTIENGESELLSCHAFT, MUNICH (DE)

(21) Appl. No.: 11/637,328

(22) Filed: Dec. 12, 2006

(30) Foreign Application Priority Data
Dec. 13, 2005 (DE) 10 2005 059 550.2

(51) Int. Cl. G01B 11/24

(52) U.S. Cl. 356/609

(57) ABSTRACT

An optical measuring device for measuring an inner wall of a cavity has a confocal proximity sensor. The beam path of the illumination light and the measuring light is deflected by a rotatably mounted reflector. By introducing an object-side end of the measuring device into the cavity a peripheral side wall of the cavity is measured. The reflector is rotated about an axis of rotation which coincides with the longitudinal axis of the optical measuring device. The inner wall is scanned along a line that revolves around the axis of rotation. The optical measuring device is equipped with two confocal proximity sensors. At the object-side end of the measuring device dual optics with a plurality of optical components are provided, by which the illumination beams of the two confocal proximity sensors are focused diametrically outwards at mutually opposing scanning points on the inner wall of the cavity.

### BACKGROUND OF THE INVENTION

The invention relates to an optical measuring device for measuring the inner wall of a cavity formed in an object according to the confocal imaging principle. The invention relates in particular to an optical measuring device of this type for measuring a cylindrical drill hole and/or for measuring the auricular canal of a human or animal organism.

When producing aircraft a large number of individual joins are necessary to connect different components of an aircraft to each other. Thus for example supporting surfaces are fastened to the aircraft fuselage by means of a large number of riveted joints. Since the precision of the joins has to be extremely high for safety reasons the drilling operations required for a riveted joint must be carried out with a high degree of accuracy, so an optimally fitting rivet may always be used for the respective drill hole. Owing to the size of the individual components that are to be joined together the drill holes are typically drilled using mobile drills which for drilling are brought close to the large component. The precision of the drilled holes in this case is typically slightly lower however than the precision of drill holes which are drilled using stationary precision drills. For this reason accurate measurement of the respectively drilled hole is required in aircraft construction in order to actually also use the appropriate rivet for the hole. The cylindrical drill holes are measured nowadays by means of capacitive measuring methods which, however, are very unreliable and have low spatial and depth resolutions.

Special coordinate measuring machines are also known for measuring cylindrical cavities, which machines allow accurate measurement of cylindrical drill holes. The measuring rate of measuring machines of this kind is conventionally very low, however. This type of coordinate measuring machine can also usually only be used stationarily in special measuring laboratories, so the respective object to be measured has to be brought to the measuring machine. Use in the aircraft industry when measuring cavities in particularly large objects, for example in the fuselage of an aircraft or in the supporting surface of an aircraft, is eliminated as a result.

Even with three-dimensional measurements of cavities in the human body it is desirable to carry out a measurement with a high degree of precision and with a high degree of measuring accuracy. Measurements of this kind are necessary for example when adjusting a hearing aid in a human auricular canal. To adjust a hearing aid at present an impression of the auricular canal is taken which is measured using a separate three-dimensionally resolving optical measuring device. Using the three-dimensional impression data obtained a hearing aid that is individually adapted for each patient may be provided. However, the method of impression taking has the drawback that the auricular canal is not directly measured but only indirectly by way of a measurement of the impression. This leads to inaccuracies in the hearing aids produced and to accordingly reduced wearing comfort.

For high-precision, three-dimensional measurement of small objects an optical proximity sensor is known from DE 196 084 68 C2 which is based on the confocal optical imaging principle. This type of proximity sensor, which is illustrated for example in FIG. 7 of said document, comprises a punctiform light source and a punctiform receiver. The punctiform light source is imaged onto a surface of an object to be measured. The punctiform receiver is arranged in the image-side measuring region confocally with the punctiform light source. The proximity sensor is distinguished at the object side by coaxial guidance of illumination light and measuring light. The optical distance between the punctiform receiver and the object to be measured may be varied by using an oscillating mirror system. By determining the maximum light intensity measured by the receiver as a function of the position of the oscillating mirror system, it is possible to determine the height of the respective measuring point on the surface of the object to be measured.

From DE 101 258 85 B4 a sensor device for performing rapid optical measurement of distances according to the confocal imaging principle is known in which the punctiform light source and the punctiform light receiver are produced by means of one end of an optical fiber. The sensor device is constructed from two modules, an optical module and an electronic module. The optical module, which for a measuring process has to be brought into the vicinity of the object being measured, may therefore be produced in a compact design. The electronic module is connected to the optical module by the optical fiber, so with an appropriate length of the optical fiber the electronic module can be situated at a great distance from the object to be measured.

From EP 1 398 597 A1 there is known a confocal distance sensor which instead of a moving reflector or a movably mounted optical system comprises an optical imaging system which due to a chromic aberration focuses different spectral components of a preferably white illumination light at different distances from the optical imaging system. By appropriate color analysis of the light backscattered by an object surface to be measured the distance between the surface to be measured and that of the distance sensor may be determined.

### SUMMARY OF THE INVENTION

The object underlying the invention is to provide an optical measuring device for measuring the inner wall of a cavity formed in an object, which measuring device allows rapid and, at the same time, precise measurement.

This object is achieved by an optical measuring device for measuring the inner wall of a cavity formed in an object and in particular for measuring a cylindrical drill hole and/or for measuring the auricular canal of a human or animal organism. The optical measuring device according to the invention comprises a punctiform optical transmitting element, set up for emitting illumination light, focusing optics for focusing the illumination light in an object region, and a punctiform optical receiving element, which with respect to the focusing optics is arranged confocally with the optical transmitting element, and which is set up to receive measuring light that is at least partially backscattered from the inner wall of the cavity to be measured and is guided by the focusing optics onto the receiving element. The optical measuring device also comprises an evaluation unit, which is coupled to the receiving element and which is set up in such a way that a maximum intensity of measuring light can be detected. The optical measuring device according to the invention also comprises a reflector which is arranged in the beam path of the illumination light and the measuring light. The reflector can be rotated about an axis of rotation, so the inner wall of the cavity to be measured can be scanned by the illumination light along a line that revolves around the axis of rotation.

The invention is based on the recognition that, as a result of a deviation of the beam path of the illumination light or measuring light, surface measurement is even possible if the surface is the inner wall of a cavity to be measured in which the rotating reflector is introduced during measurement of the cavity. The reflector is preferably inclined relative to the striking illumination light such that the illumination light is guided into a beam path which runs perpendicular to the axis of rotation. This means that the reflector is inclined at angle of 45° relative to the axis of rotation or the beam path of the illumination light striking the reflector. The illumination light is therefore guided perpendicular to the axis of rotation, onto the inner wall of the cavity, with the focal point of the illumination light describing a circle that revolves around the axis of rotation.

Reference is made to the fact that the punctiform elements, the optical transmitting element and the optical receiving element may also be produced by combining a planar, optical or optoelectronic element with a perforated plate located in front of it.

Compared with known optical measuring machines the described optical measuring device has the advantage that the measuring device can in particular be produced perpendicular to the axis of rotation in a very compact, i.e. very narrow, construction. Therefore only one part of the optical measuring device, namely the rotatably mounted reflector, has to be introduced into the cavity to measure the inner wall thereof. The remaining components of the optical measuring device do not have to be introduced into the cavity for rapid and precise measurement of the inner wall, so an object-side part of the optical measuring device may be produced inside a compact design. This creates the possibility of being able to use the optical measuring device as a mobile apparatus for measuring cylindrical drill holes and for measuring the auricular canal of a human or animal organism.

The measuring accuracy of the optical measuring device may be increased further by means of suitable image processing algorithms.

In one embodiment, the optical measuring device also comprises a housing and an optical measuring head which is displaceably mounted, relative to the housing, along a displacement axis. The transmitting element, the focusing optics, the receiving element and the reflector are associated with the optical measuring head. Arrangement of said components of the optical measuring device in a displaceably mounted measuring head has the advantage that the cavity can be measured along a large number of different circles which are situated at various depths of the cavity and not only along a circle situated at a specific depth of the cavity. The displacement axis preferably coincides with the axis of rotation of the rotatably mounted reflector. This allows easy complete measurement of the inner wall at various depths of the cavity.

In a further embodiment, the optical measuring device also comprises a drive for axial displacement of the measuring head and a position measuring system for detecting the displacement position of the measuring head relative to the housing. This advantageously allows particularly precise axial positioning of the measuring head and, resulting therefrom, a particularly precise and complete measurement of the inner wall structure of the cavity to be measured.

In another embodiment, the housing comprises adaptation elements for defined positioning of the optical measuring device on the object. Adaptation elements may for example be suction cups or any other type of mechanical coupling element which during a measuring process ensures precise adjustment of the optical measuring device relative to the cavity to be measured.

When measuring a human auricular canal for the purpose of adapting a hearing aid, the described measuring device, in contrast to known impression methods, also allows precise measurement of the auricular canal in deeper regions. As a result hearing aids can also be accurately manufactured for use in deeper regions of the auricular canal, so the corresponding hearing aids may be better adapted to the respective eardrum. As a result much greater efficiency and therefore better patient hearing in each case may be achieved compared with a hearing aid situated further out in the auricular canal.

In one embodiment, the optical measuring device also comprises a rotary drive for rotating the reflector about the axis of rotation and an angle of rotation detector for detecting the current angle of rotation of the reflector. The angle of rotation detector may preferably be coupled to the rotary drive by a control loop, so a precisely defined rotation of the reflector may be achieved. The respective scanning points of the optical measuring device may thus be precisely determined, so, based on the respective scanning point, particularly high accuracy of the optical measurement may be achieved.

In contrast to the three-dimensional optical sensors, which determine height data according to the triangulation principle, no different illuminating and observation devices are required for determining distance values in the measuring devices described here. The measuring devices may therefore be compactly constructed in the form of what are known as hand-held systems. It is advantageous in this connection that pre-centering of the respective hand-held system relative to the cavities to be measured, in particular to the cylinder-shaped cavities, takes place to ensure accuracy. This may take place by way of mechanical centering jaws which can optionally be removed after centering and fixing of the hand-held system.

In yet another embodiment, the optical transmitting element and/or the optical receiving element is/are produced by the end of an optical fiber. The transmitting element and the receiving element may thus also be easily arranged at the same position, so perfect confocal arrangement between transmitting element and receiving element is automatically always ensured. The optical measuring device may thus be produced without great adjustment effort.

To optically couple the transmitting element with a light source and the receiving element with a light detector, the other end of the optical fiber is for example split into two partial ends or is optically coupled to a beam splitter. In both cases care should be taken that at the other end of the optical fiber an optical channel is optically coupled to the light source and the other optical channel optically coupled to the light detector.

Use of an optical fiber also has the advantage however that optoelectronic components, such as a light-emitting diode acting as a light source or a photodiode acting as a light detector, may be arranged spatially separate from the optics or the rotating reflector, so the object-side end of the optical measuring device can be produced in a particularly compact design.

Light-emitting diodes or semi-conductor lasers, which ensure a high light efficiency with low power requirement, are particularly suitable as light sources. Photodiodes for example, which can optionally be used in connection with a screen arranged in front and which have a high light sensitivity, are suitable as light detectors. Optoelectronic components of this type also have the advantage that they are inexpensive optoelectronic components.

According to a preferred embodiment, in the beam path between transmitting element and object region there is arranged a dispersive optical element, and the receiving element comprises a spectral resolution, so the maximum intensity of measuring light, which strikes the receiving element, can be detected by the evaluation unit as a function of the wavelength of the measuring light.

This embodiment therefore produces a wavelength-dependent spatial splitting of the focal positions. This splitting is particularly clear if white illumination light or at least one illumination light with a broad color spectrum is used. The confocal measurement then takes place by way of a simple spectral analysis of the measuring light at least partially backscattered at the inner wall of the cavity to be measured. The measuring accuracy is particularly high in this case if the focal positions of the individual spectral fractions of the illumination light are close to each other.

The receiving element can for example be a spectrally resolving point detector which can be produced by a spectrally resolving junction-type detector in connection with a perforated plate arranged in front of it with an approximate diameter of 20 μm to 100 μm. Alternatively a spectrometer may also be arranged behind the perforated plate and guide the individual color fractions in slightly different directions. The wavelength-dependent intensity measurement then takes place in a known manner by a spatially resolved light detector.

The use of a dispersive optical element has the advantage that the optical measuring device, with the exception of the rotatable reflector, does not require any more components which necessitate a mechanical movement for optical measurement. The optical measuring device may thus be produced in a mechanically very robust construction as well as in a compact design, so the probability of failure is correspondingly low even in the case of mechanical shocks to the optical measuring device. As a consequence of its great robustness, the optical measuring device may thus be used in a very versatile manner, i.e. may also be used in a manufacturing environment that is very harsh in mechanical terms.

According to another advantageous embodiment the focusing optics constitute the dispersive element. Furthermore, provided between the focusing optics and the reflector is a light conveying element which together with the reflector is rotatably mounted about the axis of rotation. The light conveying element may be produced from any desired material which is optically transparent. In this case it is only necessary for the light broken by the focusing optics to be able to spread out in such a way that the optical imaging or focusing is not impaired by the focusing optics, or is not impaired in a precisely defined manner. The light conveying element, which, for example, is a rod, may also be used as a mechanical holding device for the reflector rotating about the axis of rotation.

In a further preferred embodiment the optical measuring device also comprises means for varying the focal position. The means for varying the focal position can, for example, be a displaceably mounted mirror or a retroreflector. The depth range in which the focal position may be varied defines the measuring range of the optical measuring device in the process.

The means for varying the focal position comprises in one embodiment a bearing, which allows displacement of the focusing optics along a direction of displacement. In this case the direction of displacement runs parallel to the optical axis of the focusing optics. A variation over time in the focal position can be achieved particularly easily by the displacement of the focusing optics, i.e. in particular without additional further reflectors.

According to a further preferred embodiment the focusing optics are arranged between reflector and object region and can be rotated together with the reflector about the axis of rotation. In the process the focusing optics are held in a, with respect to the axis of rotation, radial, position by means of a spring element. The radial position may be varied under the influence of a centrifugal force which acts on the focusing optics during a rotation. With this type of passive mounting of the focusing optics in which no active actuators are required for a displacement of the focusing optics, the desired position of the focusing optics depends solely by way of what is known as Hooke's law on the spring constant of the spring element and on the rotational speed, in particular the angular velocity, of the reflector. As a result mounting can be easily achieved inside a compact design, so even cavities with a very small internal diameter may be measured by the optical measuring device.

Reference is made to the fact that an additional reflector, for example a retroreflector, can be mechanically coupled to the spring element instead of the moving focusing optics, in addition to fixed focusing optics. The additional reflector must then be passively mounted in such a way that the focal position of the illumination light also changes as a function of the centrifugal force caused by the rotation.

In a further embodiment the means for varying the focal position is an active actuator. This has the advantage that the focal position can be adjusted independently of the respective angular velocity.

The means for varying the focal position also comprise an additional position measuring system. This has the advantage that the focal position can be varied particularly precisely by a closed-loop control system which comprises a control loop connected between the positioning measuring system and the active actuator. The inner wall may be measured thereby with particularly high accuracy.

According to a further, particularly preferred embodiment, the optical measuring device thus also comprises (a) an additional punctiform optical transmitting element, set up to emit additional illumination light, (b) additional focusing optics for focusing the additional illumination light into an additional object region, (c) an additional punctiform optical receiving element which, with respect to the additional focusing optics, is arranged confocally with the additional transmitting element, which is set up to receive additional measuring light that is at least partially backscattered from the inner wall of the cavity to be measured and guided onto the additional receiving element by the additional focusing optics and which is also coupled to the evaluation unit, so a maximum intensity of additional measuring light, which strikes the additional receiving element, can be detected. The optical measuring device also comprises (d) an additional reflector which is arranged in the beam path of the additional illumination light and the additional measuring light. The additional reflector is arranged at an angle to the reflector and can be rotated about the axis of rotation together with the reflector, so the inner wall of the cavity to be measured may also be scanned by the additional illumination light along a line that revolves around the axis of rotation, wherein, with respect to the axis of rotation, the illumination light and the additional illumination light are guided onto the inner wall of the cavity in different directions.

This embodiment is based on the recognition that the optical measuring device may be equipped with a second confocal proximity sensor which, at the same time as the first confocal proximity sensor, scans the inner wall of the cavity to be measured at a different measuring point. This advantageously allows recording of the height data of the inner wall to be measured that is faster by a factor of two than the use of a single confocal proximity sensor in the optical measuring device.

Reference is made to the fact that the term “height data” in this connection is taken to mean the distance values of the respective scanning points on the inner wall to be measured from the axis of rotation.

With respect to the axis of rotation, the object region and the additional object region are in one embodiment arranged diametrically to each other. This means that the two scanning regions are mutually offset at an angle of 180°. A possible non-central arrangement of the axis of rotation with respect to the cavity to be measured may be corrected by an appropriate data evaluation by way of this type of simultaneous measurement of the cavity at diametrically opposed points. Drunkenness of the rotating axis of rotation may thus advantageously be compensated.

### BRIEF DESCRIPTION OF THE SEVERAL VIEWS OF THE DRAWINGS

Further advantages and features of the present invention may be found in the following exemplary description of the currently preferred embodiments. In the drawings, the reference numerals of identical or mutually corresponding components differ only in their first numeral and/or by an appended letter. In schematic views in the drawings:

FIG. 1 shows an optical measuring device with dispersive focusing optics for simultaneously generating spectrally different focal positions,

FIG. 2 shows an optical measuring device with dispersive focusing optics for simultaneously measuring the distance at two different scanning points,

FIG. 3a shows an optical measuring device with focusing optics which are held in a displacement position by an equilibrium of forces between a spring force and a centrifugal force,

FIG. 3b shows an enlarged view of the passive mounting of the focusing optics illustrated in FIG. 3a,

FIG. 4 shows an optical measuring device for measuring cylindrical inner surface areas at diametrically opposed scanning points with active drives to vary the focal position, with optical coupling taking place between transmitting element or receiving element and a light source or a light detector via a fiber optic,

FIG. 5 shows a variation of the measuring device illustrated in FIG. 4, with optical coupling taking place between transmitting element or receiving element and a light source or a light detector via general-diffuse optics, and

FIG. 6 shows an enlarged view of a further variation of the measuring device illustrated in FIG. 4, with two scanning beams being produced by splitting of illumination light generated by a single punctiform optical element, the punctiform optical element being produced by the end of an optical fiber.

### DETAILED DESCRIPTION OF THE INVENTION

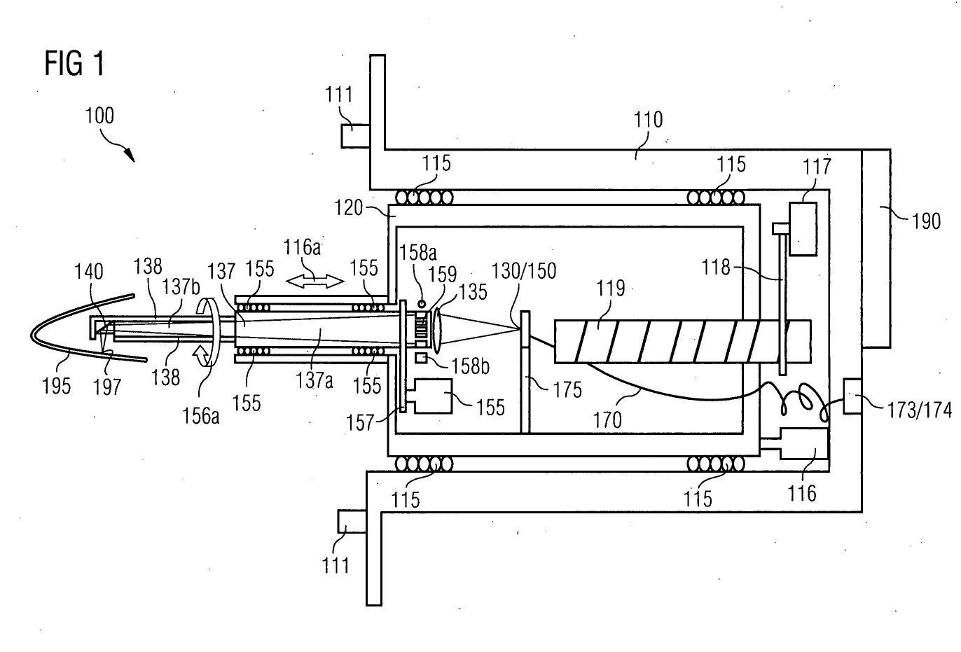

FIG. 1 shows a confocal measuring device 100 comprising what is known as a chromatic confocal proximity sensor. The measuring device 100 illustrated here is used to measure the auditory canal of an auricle 195. Spatial data of the inner structure of the auditory canal can be ascertained in the process, so a precisely fitting hearing aid may be produced.

The measuring device 100 comprises a housing 110 on which adaptation elements 111 are provided which allow defined positioning of the housing 110 on the side of a patient's head (not shown). Provided in the housing 110 is a measuring head 120 in which the actual chromatic confocal proximity sensor is constructed. The measuring head 120 is axially displaceably mounted relative to the housing 110, so the measuring head 120 can be positioned relative to the housing 110 along a direction of displacement 116a by means of an axial drive 116. To ensure defined axial displacement of the measuring head 120 a plurality of linear bearings 115 are provided that are arranged between an outer wall of the measuring head 120 and an inner wall of the housing 110. To determine the exact axial displacement position of the measuring head 120 relative to the housing 110 there is also provided an axial position measuring system 117 which comprises a sensor 118 which measures the respective displacement position of the measuring head 120 on a scale 119 provided on the measuring head 120.

A point light source 130 which is produced by the end of an optical fiber 170 is situated in the measuring head 120. The end of the optical fiber 170 is spatially fixed in the measuring head 120 by means of a holding device 175. The optical fiber 170 is preferably what is known as a multi-mode fiber, so the effective cross-sectional area of the point light source 130 is a circular disc with a diameter of just a few μm. Light is fed into the optical fiber 170 by means of an optoelectronic module which is optically coupled to the other end of the optical fiber 170 and which has a white light source 173 and a spectrally resolving light detector 174. The second end of the optical fiber 130 is therefore optically coupled to the white light source 173 and to the light detector 174, so the first end of the optical fiber 170 is not only the point light source 130 but a point light detector 150 as well.

Operation of the chromatic confocal proximity sensor will be described hereinafter: illumination light emitted by the point light source 130 strikes focusing optics 135 which comprise a high chromatic aberration. The focusing optics 135 are fastened to a glass rod 137 which is rotatably mounted relative to the measuring head 120 by means of a plurality of pivot bearings 155. The glass rod 137 comprises a thick portion 137a and a thin portion 137b, with the gradual taper of the glass rod 137 being selected such that the illumination light focused by the focusing optics 135 may freely spread, without lateral reflections on the outer surface area of the two glass rod portions 137a and 137b, as far as to the exit at an end face of the portion 137b. Provided on the thin portion 137b of the glass rod 137 is a protective covering 138 which extends beyond the end of the glass rod 137b. The protective covering 138 is also used as a holding device for a reflector 140. The illumination light emitted by the point light source 130 has a large spectral width. The illumination light is preferably white light. Owing to the dispersion of the focusing optics 135 the illumination light is focused to different extents as a function of the respective spectral fraction, so after a reflection at the reflector 140 different focal positions 197 are produced for different color fractions.

Owing to the confocal arrangement between point light source 130 and point light detector 150, which according to the exemplary embodiment illustrated here are situated at the same location, of the measuring light at least partially backscattered at the inner face of the auricle 195 the color fraction most strongly detected by the point light detector 150 is that of which the associated focal position is located precisely on the surface of the inner wall of the auricle 195. The distance of the respective scanning point from the proximity sensor or from the reflector 140 may thus be ascertained by corresponding color analysis of the at least partially backscattered measuring light coupled into the optical fiber 170. For this purpose the optoelectronic module comprises either a spectrally resolving light detector 174 or a spectrometer which is provided in front of the light detector 174, which in this case is a spatially resolving photodiode array.

To completely measure the inner wall of the auricle 195 the glass rod 137 is rotatably mounted in the measuring head 120 by means of a plurality of pivot bearings 155. The glass rod 137 is rotated by means of a rotary drive 156 which is coupled to the glass rod 137 by a belt 157. With appropriate driving of the rotary drive 156, which takes place via an electronic module 190, the glass rod 137, and with the glass rod 137 the reflector 140 as well, may be rotated, for example anti-clockwise, in a direction of rotation 156a. Apart from the electronic drive devices for the rotary drive 156 the electronic module also comprises the electronic open-loop control, closed-loop control and measuring devices for all electrical and optoelectronic components of the confocal measuring device 100.

To have precise knowledge about the current angle of rotation of the reflector 140 in each case a marking 159 is formed on the leading end of the glass rod 137a. This marking can be detected by means of a measuring device which contains a light-emitting diode 158a and a photodiode 158b. The marking 159 includes a plurality of lines that are not optically transparent, so by counting the light cycles which lead to repeated blocking of the light emitted by the light-emitting diode 158a and detected by the photodiode 158b when the glass rod 137 is rotated, the current angle of rotation may be determined.

Reference is made to the fact that precise control of the rotational speed of the glass rod 137 may be achieved by means of the angle of rotation measuring device in addition to the current angle of rotation of the glass rod 137 being exactly measured. This can be achieved for example in that the photodiode 158b is coupled to the rotary drive 156 by means of a control loop. The rotational speed can also be controlled by the electronic module 190.

The inner structure of the auricle 195 can be completely measured for example in that the leading part of the measuring head 120 is introduced deep into the auricular canal and is slowly withdrawn therefrom with constant rotation of the measuring head 120. Measurement of the auricular canal, in which the measuring head 120 is merely pushed toward the outside, has the advantage that the auricular canal 195 is only deformed slightly and, moreover, in a defined manner by the measuring head 120 rubbing on the inner wall of the auricular canal 195. Compared with the case in which the measuring head 120 is inwardly introduced into deeper regions of the auricular canal 195, and thus the tissue of the auricular canal 195 is pushed together in the event of rubbing, slow withdrawal of the measuring head 120 rubbing on the inner wall of the auricular canal 195 causes much less deformation of the auricular canal 195 to be measured.

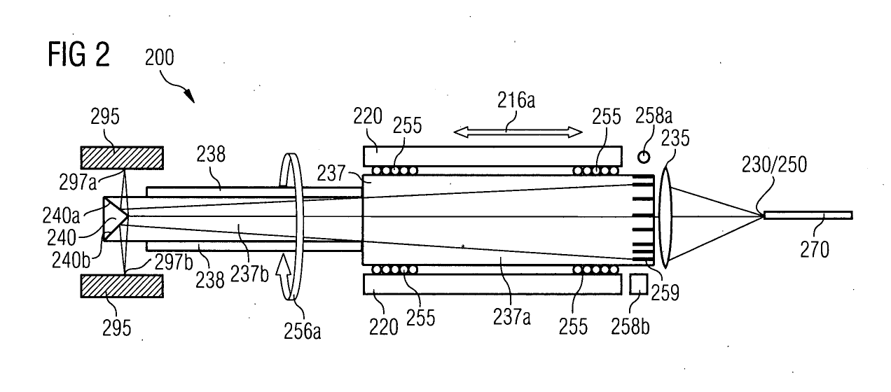

FIG. 2 shows the leading, i.e. the object-side part of a chromatic, confocal measuring device 200 which differs from the confocal measuring device 100 merely in that the illumination light is focused on two diametrically opposed focal regions 297a and 297b. The interior of an object 295, which is preferably a cylindrical cavity, can thus be measured at two scanning points simultaneously in each case. Apart from a housing (not shown) the confocal measuring device 200 comprises a measuring head 200 which is partially shown in FIG. 2 and which is axially displaceable relative to the housing (not shown) along a direction of displacement 216a. The confocal measuring device 200 also comprises a point light source 230 and a point light detector 250 which is produced by one end of an optical fiber 270.

The focusing optics 235 acting as a chromatic lens, the glass rod 237 with the thick portion 237a and the thin portion 237b and the protective covering 238 have already been described above with reference to FIG. 1 and will therefore not be described again in detail at this point. The same applies to the pivot bearing 255 which allows rotation of the glass rod 237 along the direction of rotation 256a and to the angle of rotation measuring device which comprises the light-emitting diode 258a, the photodiode 258b and the marking 259 on the glass rod 237.

As may be seen from FIG. 2 the rotatable reflector is a prism 240 which has two limiting faces 240a and 240b. These limiting faces 240a and 240b act as rotatable reflectors. The illumination beam focused by the focusing optics 235 strikes the apex of the prism 240, so a portion of the illumination light is guided in the direction of the focal region 297a and a further portion of the illumination light is guided in the direction of the focal region 237b. There is then analogously an at least partial reflection at the inner wall of the object 295, so owing to the confocal arrangement of point light source 230 and point light detector 250 the spectral region, of which the focal position exactly coincides with the inner surface of the cavity formed in the object 295, is preferably coupled into the light sources 270.

Reference is made to the fact that in the exemplary embodiment illustrated here, only one point light source 230 and one point light detector 250 are provided despite the two diametrically opposed scanning regions 297a and 297b. This means that when evaluating the measuring data no distinction can be made between the two scanning regions 297a and 297b. As a result the measuring device 200 should be introduced into the cylindrical hole to be measured exactly in the center for precise measurement of the cylindrical cavity formed in the object 295. In the case of non-central measurement of the hole, an indistinct measuring signal is produced because light in a first spectral range is preferably coupled into the optical fiber 270 by the one focal region 297a and light with a second spectral range, different from the first spectral range, is preferably coupled into the optical fiber 270 by the second focal region 297b.

An intentionally non-uniform measuring signal of this type in which two maximum intensities are measured in spectral ranges that are different from each other, may, however, also be used to determine the eccentricity, i.e. the deviation of the axis of rotation of the measuring device 230 from the center line of the cylindrical hole in the object 295. This determination can, for example, take place in that, in addition to the measured values for the absolute position of the two intensity maxima on the frequency axis, the frequency separation of the two intensity maxima may also be used for data evaluation.

Reference is made to the fact that optical decoupling of the two scanning points 297a and 297b can take place in that instead of one optical fiber 270 two optical fibers are used, of which the ends constitute a point light source and a point light detector respectively. To ensure a fixed allocation of the respective optical fiber to the scanning points 297a and 297b it is necessary in this case for the two optical fibers to also rotate about a common axis of rotation together with the glass rod 237.

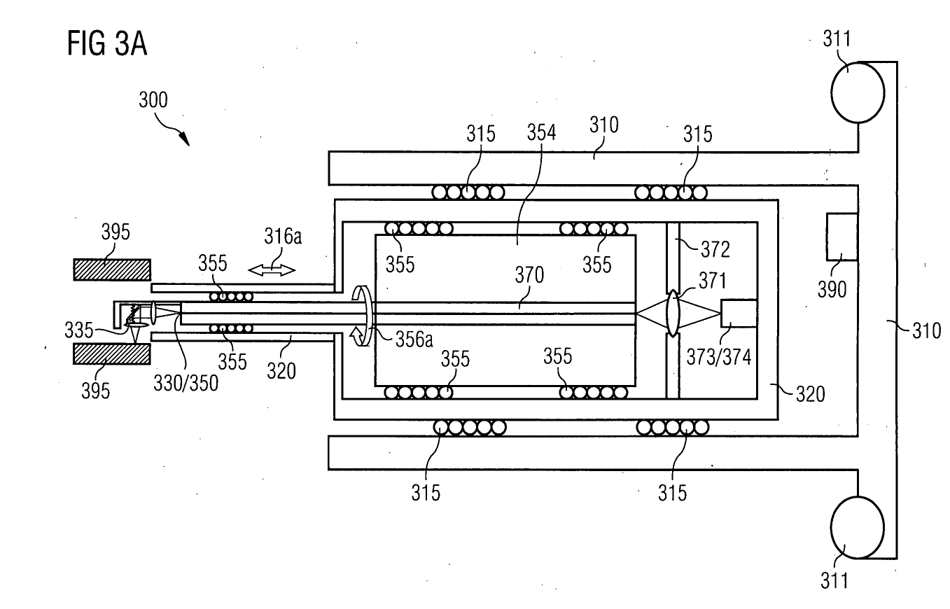

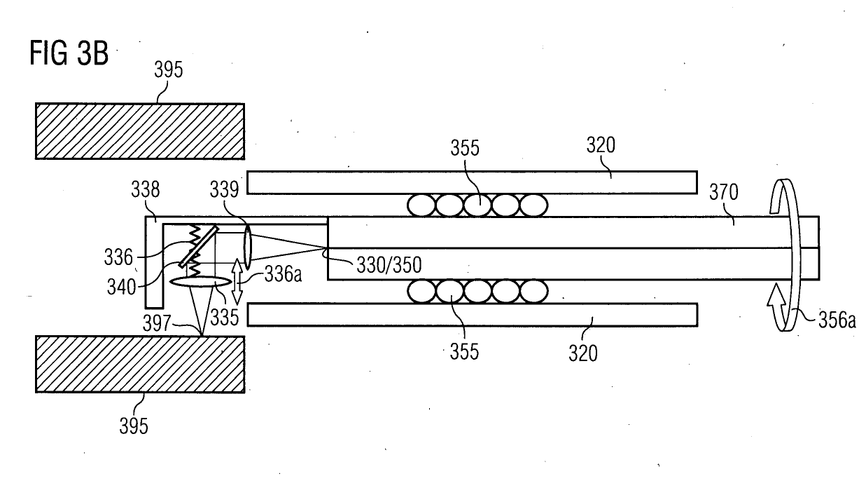

According to a further exemplary embodiment of the invention FIG. 3a shows a confocal measuring device 300 in which instead of chromatic focusing optics, radially displaceable focusing optics 335 are provided. The measuring device 300 comprises a housing 310 on which adaptation elements 311 are provided which, in a manner not shown, allow fixing of the measuring device 300 relative to an object 395 in which a cylindrical cavity to be measured is formed. The adaptation elements 311 can for example comprise suction cup-like, mechanical coupling elements which allow firm, yet releasable, fixing of the housing 311 relative to the object 395. The measuring device 300 also comprises a measuring head 320 which can be moved relative to the housing 310, along a direction of displacement 316a, by means of a plurality of linear bearings 315 and an axial drive (not shown).

A cylindrical rotational body 354 is rotatably mounted in the measuring head 230 by means of a plurality of pivot bearings 355, so the rotational body 354 can be rotated along a direction of rotation 356a by means of a rotary drive (not shown). An optical fiber 370 is centrally cast in the rotational body 354. When the rotational body 354 is rotated the optical fiber 370 is thus rotated about the same axis of rotation which coincides with the longitudinal axis of the optical fiber 370. The optical fiber 370 is used as a light conveying element from a laser diode 373 to a point light source 330 and as a light conveying element from a point light detector 350 to a photodiode 374.

The central arrangement of the optical fiber 370 in the rotational body 354, which is in turn arranged centrally with respect to the measuring head 320, means that when the rotational body 354 is rotated the fiber core of the optical fiber 370 is always in a spatially constant position. This thus allows constant light conveying both toward the point light source 339 and away from the point light detector 350 even during a rotation of the optical fiber 370.

Reference is made to the fact that as far as the optical fiber 370 is concerned it is not a matter of the optical fiber 370 being arranged centrally in the rotational body 345 over its entire length. The only decisive aspect is that the two ends of the optical fiber 370 are situated on the rotational axis of the optical fiber 370. The spatial course of the optical fiber 370 between these two ends is not important as long as the optical fiber 370 is not so severely curved that, at least partially, total reflection does not occur for the light guided in the optical fiber 370.

The laser diode 373 and the photodiode 374 are constructed as a joint optoelectronic module. It is thus not necessary for electronic or optoelectronic components of the confocal measuring device 300 to be situated on the object, so the object-side measuring head, which during a measuring process is introduced into a cylindrical cavity that is formed in the object 395 and is to be measured, can be produced in a compact design.

Illumination light is coupled into the optical fiber 370 and measuring light decoupled from the optical fiber 370 and into the photodiode 374 by focusing optics 371 which are fixed in the measuring head 320 by means of a holding device 372. The optoelectronic module with the laser diode 373 and the photodiode 374 is coupled to an electronic module 390 which fulfils all functions of the electronic open-loop control, closed-loop control and measuring devices that are required for operation of the confocal measuring device 300, by corresponding electronic circuits.

FIG. 3b shows the leading, i.e. the object-side part of the confocal measuring device 300 in an enlarged depiction. The object-side end of the optical fiber 370, which is rotated about its center line, along the direction of rotation 356a, is used as the point light source 330.

The illumination light emitted by the point light source 330 is guided by stationary focusing optics 339 onto a rotatable reflector 340. The focusing optics 339 and the reflector 340 are fixed to a holding device 338 in a manner not shown. The holding device 338 is fastened to the optical fiber 370, so when the optical fiber 370 is rotated, the focusing optics 339 and the reflector 340 automatically rotate about the axis of rotation or the longitudinal axis of the optical fiber 370.

After a reflection at the rotatable reflector 340 the illumination light strikes focusing optics 335 which are displaceably mounted along a radial direction of displacement 336a. The focusing optics 335 are held by a spring 336 which is situated between the holding device 338 and the displaceably mounted focusing optics 335.

When the focusing optics 335 are rotated about the axis of rotation, rotation taking place together with rotation of the optical fiber 370, a centrifugal force thus acts on the focusing optics 335 which increases with the square of the angular velocity of the rotation. An equilibrium of forces, which under stationary conditions, i.e. after a transient response, leads to a fixed radial position of the focusing optics 335, is produced by the spring force of the spring 336, which may be a helical spring, a leaf spring or any other desired spring element or elastic element. The respective radial position of the focusing optics 335 may thus be adjusted by the angular velocity. The position in this case also depends on constant parameters, such as the mass of the optics, the spring constant of the spring 336 and the zero position of the spring 336. The position of the focal point 397 of the illumination light may thus be adjusted by an adjustment of the angular velocity.

According to the confocal principle the intensity of measuring light coupled onto the point light detector 335 or into the optical fiber 370 is at its maximum if the focal point 337 precisely strikes the inner surface of the cavity formed in the object 395. The diameter of the cylindrical cavity formed in the object 395 may thus be determined by an evaluation of the measuring signal measured by the photodiode 374 as a function of the angular velocity of the rotating focusing optics 335.

To measure the entire inner wall of the cavity formed in the object 395 an axial displacement of the object-side components of the confocal measuring device 300 along the direction of displacement 316a is required in addition to the rotation of these components.

A suitable measuring sequence for complete measurement of the cylindrical cavity consists for example in that firstly a constant rotational speed, and thus a fixed focal position, is adjusted. Continuous axial displacement follows, so the entire interior is measured in a first focal position of the illumination light. A gradual increase in the rotational speed takes place in further measuring steps, with the object-side part of the measuring device 300 being axially displaced again with every adjusted rotational speed. The cylindrical cavity in the object 395 is thus successively measured at a large number of different focal positions, so the geometry of the cylindrical cavity may be completely measured by suitable evaluation of all collected measuring signals.

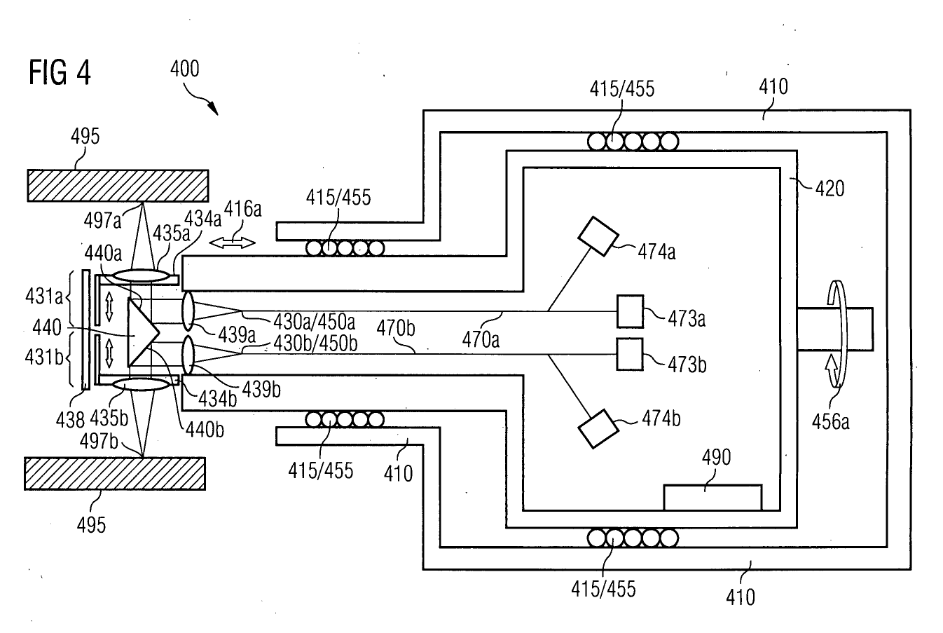

FIG. 4 shows a confocal measuring device 400 in which a cylindrical cavity of an object 495 can be simultaneously measured at two mutually independent scanning points. The measuring device 400 comprises a housing 410 in which a large number of bearings are formed. The bearings include linear bearings 415 and pivot bearings 455, so axial displacement of a measuring head 420 along a direction of displacement 416a and rotation of the measuring head 420 along a direction of rotation 456a are possible. The rotation and the axial displacement of the measuring head 420 take place by means of drives, not shown.

Two mutually independent confocal proximity sensors are constructed in the measuring head 420 and each comprises a point light source 430a or 430b and a point light detector 450a or 450b. The point light source 430a and the point light detector 450a are produced by the end of an optical fiber 470a. The point light source 430b and the point light detector 450b are analogously produced by the end of an optical fiber 470b. To couple the object-side ends of the optical fiber 470a or 470b acting as point light sources or point light detector to a respective optical transmitting element and optical receiving element, the ends, opposing the object-side end, of the optical fiber 470a or 470b are split into two partial ends in each case. A first partial end is coupled to a laser diode 473a or 473b and second partial end to a photodiode 474a or 474b in each case. The two optical fibers 470a and 470b are thus also used as light conveying means in order to bring the two point light sources 430a and 430b and the two point light detectors 450a and 450b as close as possible to the interior to be measured. The illumination light may thus be guided with a large numerical aperture onto the surface to be measured or the side wall to be measured, so high resolution may be achieved in the distance measurement.

The illumination light emitted by the point light source 430a strikes stationary focusing optics 439a which guide the illumination light onto a reflective side 444a of a prism 440. The side 440a of the prism acting as a reflector is inclined by an angle of 45° with respect to the optical axis of the illumination light. The illumination light is consequently reflected at an angle of 90° and strikes radially displaceably mounted focusing optics 435a. The focusing optics 435a are fastened to a holding device 434a which is coupled to a radial drive 431a. The radial drive 431a also comprises a position measuring system, so the current displacement position can be precisely determined. The focal position 497a of the illumination light may be varied by a radial displacement of the focusing optics 435a. According to confocal focusing principle the intensity of the illumination light at least partially backscattered by the cylindrical inner wall of the cavity formed in the object 495 is particularly high precisely if the focal point 497a exactly strikes the inner face of the cylindrical cavity.

The illumination light, which is emitted by the point light source 430b, is correspondingly guided by focusing optics 439b onto a reflective side 440b of the prism 440. After a reflection of the illumination light at the reflective side 440b of the prism 440, which is also inclined by 45° with respect to the optical axis of the illumination light, the illumination light of the point light source 430b is then directed, diametrically to the illumination light emitted by the point light source 430a, onto the inner wall of the cylindrical cavity to be measured.

To vary the focal position 497b radially displaceable focusing optics 435b are correspondingly provided. The focusing optics 435b are fastened to a holding device 434b which is also permanently connected to a radial drive 431b. The radial drive 431b also comprises an integrated position measuring system. The focal position 497b may thus be varied by appropriate driving of the radial drive 431b. By measuring the light intensity at least partially backscattered and coupled into the optical fiber 474b the spacing of the cylindrical surface 497 from the axis of rotation (not shown) may be determined at the respective scanning point.

The complete inner wall of the cylindrical cavity is likewise measured by a combination of a rotation of the measuring head 420 along a direction of rotation 456a with a displacement of the measuring head 420 along the direction of displacement 416a.

Also provided in the measuring head 420 is an electronic module 490 which (a) comprises a large number of electronic assemblies which control or regulate the radial displacement of the focusing optics 435a and 435b, which (b) control or regulate the rotation and displacement of the measuring head 420 relative to the housing 410 and which (c) supply the optoelectronic components, which according to the exemplary embodiment illustrated here are arranged in the rotating measuring head 420, with current and evaluate the measuring signals thereof accordingly. These functionalities may of course also be completely or at least partially implemented by means of software.

Reference is made to the fact that the holding device 438 is connected to the measuring head 420 in a manner not shown. It is therefore not only the optoelectronic components arranged inside the measuring head 420, the two optical fibers 470a and 470b and the two focusing optics 439a and 439b which rotate about the axis of rotation when the measuring head rotates; the components directly or indirectly fastened to the holding device 438 likewise rotate about the axis of rotation (not shown). As may be seen in FIG. 4 these components are the prism 440 and the two radially displaceable focusing optics 435a and 435b.

For complete measurement of the cylindrical cavity the two following scanning sequences may for example be used, the measuring device 400 preferably being operated at a constant rotational speed in each case:

a) The interior to be measured is scanned on a line that revolves around the axis of rotation by a continuous radial displacement of the lenses 435a and 435b. This scanning is carried out at different axial positions of displacement of the measuring head 420 relative to the housing 410. As a result the cavity to be measured is measured at different depths at the lines revolving around the axis of rotation. The lenses 435a and 435b are preferably radially displaced in a continuous manner; the measuring head 420 is preferably displaced in the axial direction in discrete steps.

b) The focal position is varied by gradual displacement of the focusing optics 435a and 435b in the radial direction. For each radial displacement of the focusing optics 435a and 435b the measuring head 420 is continuously displaced along the entire axial measuring range.

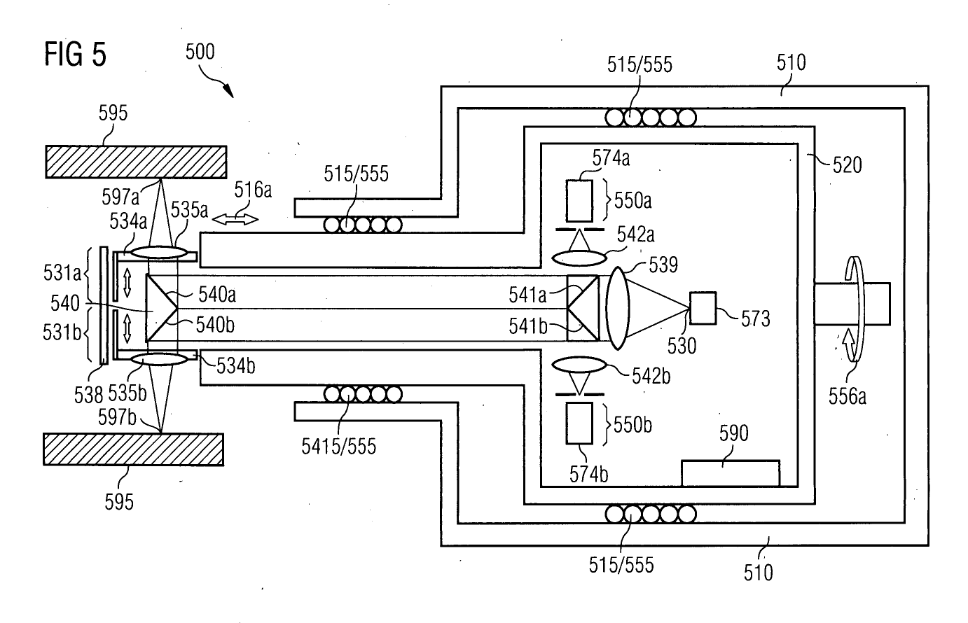

FIG. 5 shows a confocal measuring device 500 according to a further embodiment of the invention. The confocal measuring device 500 differs from the measuring device 400 illustrated in FIG. 4 merely in that the illumination light is guided in a modified manner onto a prism 540 which has two reflective sides 540a and 540b. To avoid repetitions only those components of the confocal measuring device 500 which differ from the components of the measuring device 400 with respect to their structure or function will be described hereinafter.

The confocal measuring device 500 comprises a measuring head 520 in which only one point light source 530 is provided. The point light source 530 is produced by means of a laser diode 573 which can optionally be arranged behind a perforated plate (not shown). The illumination light emitted by the point light source 530 strikes focusing optics 539 which are stationarily arranged in the measuring head 520. The focusing optics 539 transform the diverging illumination light emitted by the point light source 530 into a substantially parallel beam of rays which strikes to beam splitters 541a and 541b. After transmission through the beam splitter 541a and 541b the illumination light strikes the prism 540, in the same way as with the measuring device 400 illustrated in FIG. 4, as a parallel beam of rays and is guided by the prism in diametrically opposed directions.

The light at least partially backscattered by the cylindrical inner wall of the object 595 is coupled as measuring light in a corresponding manner (see FIG. 4) into the beam path between the beam path 540 and the two beam splitters 541a and 541b. After a reflection at the beam splitter 541a or 541b the illumination light strikes focusing optics 542a or 542b, likewise stationarily arranged in the measuring head 520, which guide the measuring light onto a point light detector 550a or 550b. The point light detector 550a or 550b is produced by a photodiode 574a or 574b with a perforated plate arranged in front of it.

The confocal measuring device is controlled or regulated and the measuring signals captured by the photodiodes 474a and 474b are evaluated as in the measuring device 400 illustrated in FIG. 4 in an electronic module 590.

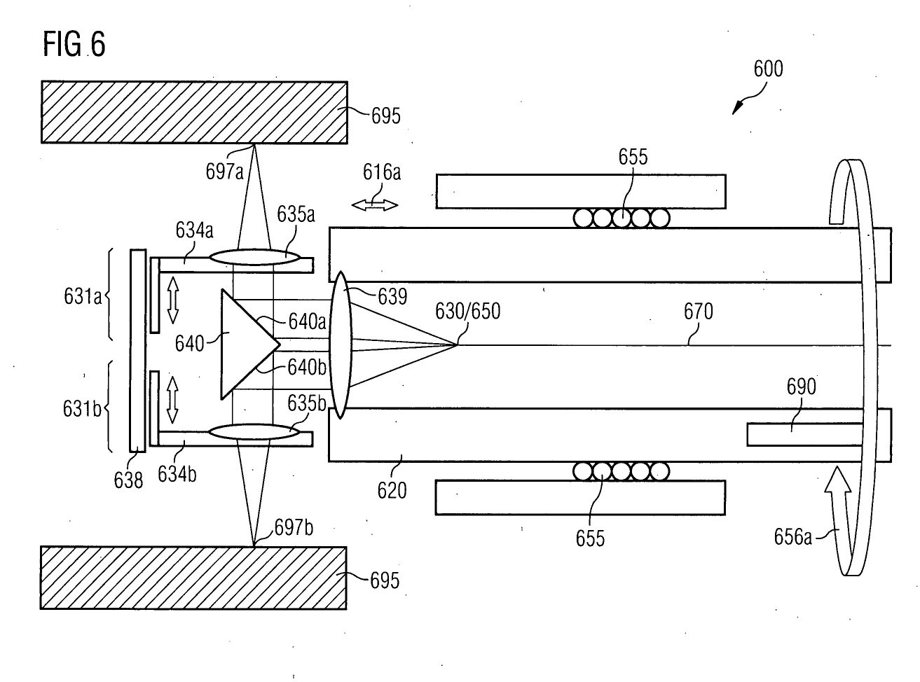

FIG. 6 shows the leading, object-side part of a further embodiment of the invention in the form of a confocal measuring device 600 which differs from the measuring device 500 illustrated in FIG. 5 in that the point light source 630 is brought closer to the object-side end of the measuring device 600 by means of an optical fiber 670 inside the measuring head 620. The illumination light emitted by the point light source 630 is transformed by means of focusing optics 639 stationarily arranged in the measuring head into a parallel beam of rays. The parallel beam of rays centrally strikes a prism 640, so the illumination light is guided by a reflection at reflective sides 640a and 640b of the prism 640 in diametrically opposed directions. The variation in the focal position and control of all mechanical, electronic and optoelectronic components of the confocal measuring device 600 by an electronic module 60 takes place in the same way as in the embodiments described above with reference to FIG. 4 and FIG. 5.

The described embodiment has the advantage that in the object-side part of the confocal measuring device 300 which constitutes the actual scanning head, a minimum number of electrical and mechanical actuators is used. This allows production of a miniaturized measuring head with extremely low dimensions, so at least the object-side tip of the measuring head can also be introduced into smaller cylindrical cavities.

A particularly compact design may be achieved if the optical components of the measuring device, which are situated in particular on the object-side part of the measuring head, are optimally adapted to a specific hole diameter that is to be measured. This means that to measure holes with diameters of different sizes a measuring head respectively adapted to the cavity to be measured should be used.

Reference is made to the fact that the embodiments described here merely represent a limited selection of possible variations of the invention. It is thus possible to suitably combine the features of individual embodiments with each other, so for a person skilled in the art a large number of different embodiments are to be regarded as having been obviously disclosed by the explicit variations here.

To summarize it should be stated that:

an optical measuring device for measuring the inner wall of a cavity formed in an object is described. The measuring device comprises a confocal proximity sensor in which the beam path of the illumination light and the measuring light is deflected by means of a rotatably mounted reflector. A peripheral side wall of the cavity may thus be measured by introduction of at least one object-side end of the measuring device into the cavity to be measured. The reflector is rotated about an axis of rotation which preferably coincides with the longitudinal axis of the optical measuring device. The inner wall is thus scanned along a line revolving around the axis of rotation.

The optical measuring device can also be equipped with two confocal proximity sensors, with dual optics comprising a plurality of optical components being provided at the object-side end of the measuring device, by means of which dual optics the illumination beams of the two confocal proximity sensors are focused preferably diametrically outwards at mutually opposing scanning points on the inner wall of the cavity to be measured. The diameter and the center of the cylindrical cavity may be precisely determined by way of the diametrical arrangement even when the measuring device is not centrally introduced into a cylindrical cavity.

The height of the lateral inner wall can be measured by means of a chromatic confocal proximity sensor in which a plurality of focal positions are simultaneously produced which each depend on the wavelength of the illumination light. The distance between the respective scanning point on the inner wall and the rotating reflector can be determined by spectral analysis of the light at least partially backscattered by the inner wall of the object and detected by a point light detector.

The focal position can take place by way of a variation in the beam path by means of a displacement of reflectors or a displacement of focusing optics. Displacement of this type may take place passively by means of a spring which is stressed by a centrifugal force of an optical component that is produced on rotation. Displacement may, however, also take place actively by means of a mechanical adjusting unit for the associated optical components of the proximity sensor. With mechanical displacement of at least one optical component of the proximity sensor a maximum intensity is precisely measured by a punctiform detector of the confocal proximity sensor if the illumination light is focused exactly on the surface of the inner wall of the cavity. The cavity can thus be completely measured by means of a large number of three-dimensional measurements by an evaluation of the maximum intensity for each scanning point.

### LIST OF REFERENCE NUMERALS

100 confocal measuring device (chromatic)
110 housing
111 adaptation element
115 linear bearing
116 axial drive
116a direction of displacement
117 axial position measuring system
118 sensor
119 scale
120 measuring head
130 point light source
135 focusing optics (chromatic lens)
137 glass rod
137a thick portion of glass rod
137b thin portion of glass rod
138 protective covering/holding device
140 rotatable reflector
150 point light detector
155 pivot bearing
156 rotary drive
156a direction of rotation
157 belt
158a LED
158b photodiode
159 marking
170 optical fiber
173 optoelectronic module/white light source
174 optoelectronic module/spectrally resolving light detector
175 holding device
190 electronic module (electronic open-loop control, closed-loop control and measuring devices)
195 object (auricle)
197 focal point
200 confocal measuring device (chromatic)
216a direction of displacement
220 measuring head
230 point light source
235 focusing optics (chromatic lens)
237 glass rod
237a thick portion of glass rod
237b thin portion of glass rod
238 protective covering
240 prism
240a/b rotatable reflector
250 point light detector
255 pivot bearing
256a direction of rotation
258a LED
258b photodiode
259 marking
270 optical fiber
295 object (with cylindrical cavity)
297a/b focal point
300 confocal measuring device
310 housing
311 adaptation element
315 linear bearing
316a direction of displacement
320 measuring head
330 point light source
335 focusing optics (radially displaceable)
336 spring
336a radial direction of displacement
338 holding device
339 focusing optics (stationary)
340 rotatable reflector
350 point light detector
354 rotational body
355 pivot bearing
356a direction of rotation
370 optical fiber
371 focusing optics
372 holding device
373 laser diode
374 photodiode
390 electronic module (electronic open-loop control, closed-loop control and measuring devices)
395 object (with cylindrical cavity)
397 focal point
400 confocal measuring device
410 housing
415 linear bearing
416a direction of displacement
420 measuring head
430a/b point light source
431a/b radial drive with position measuring system
434a/b holding device
435a/b focusing optics (displaceable)
438 holding device
439a/b focusing optics (stationary)
440 prism
440a/b rotatable reflector
450a/b point light detector
455 pivot bearing
456a direction of rotation
470a/b optical fiber
473a/b laser diode
474a/b photodiode
490 electronic module (electronic open-loop control, closed-loop control and measuring devices)
495 object (with cylindrical cavity)
497a/b focal point
500 confocal measuring device
510 housing
515 linear bearing
516a direction of displacement
520 measuring head
530a/b point light source
531a/b radial drive with position measuring system
534a/b holding device
535a/b focusing optics (displaceable)
538 holding device
539a/b focusing optics (stationary in measuring head)
540 prism
540a/b rotatable reflector
541a/b rotatable beam splitter
542a/b focusing optics (stationary in measuring head)
550a/b point light detector (produced by perforated plate)
555 pivot bearing
556a direction of rotation
573 laser diode
574a/b photodiode
590 electronic module (electronic open-loop control, closed-loop control and measuring devices)
595 object (with cylindrical cavity)
597a/b focal point
600 confocal measuring device
616a direction of displacement
620 measuring head
630 point light source
631a/b radial drive with position measuring system
634a/b holding device
635a/b focusing optics (displaceable)
638 holding device
639 focusing optics (stationary in measuring head)
640 prism
640a/b rotatable reflector
650 point light detector (produced by perforated plate)
655 pivot bearing
656a direction of rotation
670 optical fiber
690 electronic module (electronic open-loop control, closed-loop control and measuring devices)
695 object (with cylindrical cavity)
697a/b focal point

What is claimed is:

1. An optical measuring device for measuring an inner wall of a cavity formed in an object according to a confocal imaging principle, comprising:
a punctiform optical transmitting element configured to emit illumination light;
focusing optics for focusing the illumination light into an object region;
a punctiform optical receiving element,
which with respect to the focusing optics is arranged confocally with the optical transmitting element, and
which is configured to receive measuring light that is at least partially backscattered from the inner wall of the cavity to be measured and is guided by the focusing optics onto the receiving element,
an evaluation unit,
which is coupled to the receiving element, and
which is configured in such a way that a maximum intensity of measuring light, which strikes the receiving element, is detectable; and
a reflector arranged in a beam path of the illumination light and the measuring light, wherein the reflector is rotatable about an axis of rotation so that the inner wall of the cavity to be measured is scanned by the illumination light along a line that revolves around the axis of rotation.

2. The optical measuring device of claim 1, further comprising:
a housing, and
an optical measuring head which is displaceably mounted, relative to the housing, along a displacement axis, wherein the punctiform optical transmitting element, the focusing optics, the receiving element and the reflector are associated with the optical measuring head.

3. The optical measuring device of claim 2, further comprising:
a drive for axial displacement of the measuring head relative to the housing, and
a position measuring system for detecting the displacement position of the measuring head relative to the housing.

4. The optical measuring device of claims 2, wherein the housing comprises adaptation elements for a defined positioning of the optical measuring device on the object.

5. The optical measuring device of claim 1, further comprising:
a rotary drive for rotating the reflector about the axis of rotation, and
an angle of rotation detector for detecting a current angle of rotation of the reflector.

6. The optical measuring device of claim 1, wherein at least one of the optical transmitting element and the optical receiving element is provided by an end of an optical fiber.

7. The optical measuring device of claim 1, wherein:
in the beam path between transmitting element and object region a dispersive optical element is arranged, and
the receiving element comprises a spectral resolution, so a maximum intensity of measuring light, which strikes the receiving element, is detectable by the evaluation unit as a function of a wavelength of the measuring light.

8. The optical measuring device of claim 7, wherein:
the focusing optics is the dispersive optical element, and
provided between the focusing optics and reflector there is provided a light conveying element which is rotatable about the axis of rotation together with the reflector.

9. The optical measuring device of claim 1, further comprising a means for varying a focal position.

10. The optical measuring device of claim 9, wherein the means for varying the focal position comprises a bearing for displacement of the focusing optics along a direction of displacement, wherein a direction of displacement runs parallel to the optical axis of the focusing optics.

11. The optical measuring device of claim 10, wherein the focusing optics are arranged between reflector and object region and is rotatable about the axis of rotation together with the reflector, and wherein the focusing optics are held in a, with respect to the axis of rotation, radial position by means of a spring element, wherein the radial position is variable under influence of a centrifugal force which acts on the focusing optics during a rotation.

12. The optical measuring device of claim 9, wherein the means for varying the focal position is an active actuator.

13. The optical measuring device of claim 12, wherein the means for varying the focal position comprises an additional position measuring system.

14. The optical measuring device of claim 1, further comprising:
an additional punctiform optical transmitting element configured to emit additional illumination light,
additional focusing optics for focusing the additional illumination light into an additional object region,
an additional punctiform optical receiving element,
which with respect to the additional focusing optics is arranged confocally with the additional optical transmitting element,
which is set up to receive additional measuring light that is at least partially backscattered from the inner wall of the cavity to be measured, and is guided onto the additional receiving element by the additional focusing optics, and
which is coupled to the evaluation unit so a maximum intensity of additional measuring light, which strikes the additional receiving element, is detectable, and
an additional reflector arranged in a beam path of the additional illumination light and the additional measuring light, wherein the additional reflector is arranged at an angle to the reflector and is rotatable about the axis of rotation together with the reflector, so that the inner wall of the cavity to be measured is scanned by the additional illumination light along a line that revolves around the axis of rotation, wherein, with respect to the axis of rotation, the illumination light and the additional illumination light are guided onto the inner wall of the cavity in different directions.

15. The optical measuring device of claim 14, wherein, with respect to the axis of rotation, the object region and the additional object region are arranged diametrically to each other.
